(19) United States
(12) Patent Application Publication
(10) Pub. No.: US 2025/0242540 A1
(43) Pub. Date: Jul. 31, 2025

(54) SYSTEMS AND METHODS FOR SELECTIVE RESOLUTION IN METAL DROPLET ADDITIVE MANUFACTURING VIA CONTROL OF MULTI-ORIFICE NOZZLE EJECTIONS

(71) Applicant: Lawrence Livermore National Security, LLC, Livermore, CA (US)

(72) Inventor: Viktor SUKHOTSKIY, Livermore, CA (US)

(21) Appl. No.: 18/425,268

(22) Filed: Jan. 29, 2024

(51) Int. Cl. B29C 64/209; B29C 64/393; B33Y 10/00; B33Y 30/00; B33Y 50/02

(52) U.S. Cl. CPC B29C 64/209; B29C 64/393; B33Y 10/00; B33Y 30/00; B33Y 50/02

(57) ABSTRACT

The present disclosure relates to an additive manufacturing system for droplet-on-demand jetting to manufacture a part from a feedstock. In one embodiment the system comprises a printhead having a nozzle having first and second orifices for ejecting liquid droplets created from the feedstock, wherein the first and second orifices have at least one differing characteristic. A controller is provided along with a pressure pulse data file which is accessible by the controller, and which contains data needed for generating pressure pulses designed to cause ejection from one or the other of the first and second orifices of the nozzle, as needed, to form the part. A pulse generating subsystem is also included which is responsive to the controller for generating the pressure pulses relative to the nozzle, and causing ejection of liquid droplets from at least one of the first and second orifices of the nozzle.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to additive manufacturing systems and methods, and more particularly to a metal droplet additive manufacturing system and method relating to a multi-orifice nozzle capable of printing with multiple different resolutions without making any hardware changes to the nozzle.

### BACKGROUND

The statements in this section merely provide background information related to the present disclosure and may not constitute prior art.

Existing state-of-the-art metal additive manufacturing (AM) techniques rely on beam-based methods to fuse together submillimeter metal powder particles into solid 3D objects. Although successful in select industries, these layer-wise manufacturing processes require sophisticated beam-matter interaction process controls and expert operator knowledge to create metal objects with favorable material properties and dimensional accuracy. This typically results in high costs of ownership and operation as well as significant constraints on material selection.

In the current field of additive manufacturing, the resolution of a printed part is limited by the process type and the part construction strategy during the printing process. Almost universally, 3D printing is characterized by a strong tradeoff between feature resolution and printing speed. This implies that parts which require finer features take much longer to print, practically decreasing productivity or, if minimizing printing time is important, then reducing the complexity of the printed parts. One solution to this problem is to allow multi-resolution printing in the same process. For example, a 3D printing process may have a fine feature printing mode, which may be termed for example “Fine Mode”, and a coarse printing mode, which may be termed “Coarse Mode”. Additional modes such as “Infill Mode” may be used to emphasize rapid deposition during specific stages of printing. In this framework, a printer that can switch between Fine Mode, Coarse Mode, and Infill Mode upon receiving appropriate commands will offer both high resolution and fast printing times by printing fine features and contours with Fine Mode and Coarse Mode as appropriate, and then filling material into those contours using the Infill Mode. The description below shows an example of how this can be done with a nozzle that contains two orifices; however, the method may be applied to more than two orifices if needed.

An alternative metal AM process, inspired by aqueous ink-jetting and metal spray forming, relies on ejection of liquid metal droplets from a nozzle. The ejected droplets coalesce and solidify on a heated moving platform, creating a solid object. The class of material jetting AM processes based on drop-on-demand (DOD) liquid metal jetting (LMJ) continue to gain importance as lower cost alternatives to beam-based and powder feedstock methods.

LMJ AM methods have several variants, one of which utilizes a contactless magnetohydrodynamic (MHD) actuation configuration and another that uses pneumatic actuation. Existing embodiments of LMJ use either a metal or ceramic nozzle with a single orifice, where liquified metal is contained and periodically ejected on a droplet-by-droplet basis by pressure pulses. Each pulsed pressure event corresponds to a single droplet ejection (see FIG. 1). The duration, transient shape, and amplitude of the pressure pulse near the orifice is controlled by the current waveform in the MHD variant and by an electromechanical valve in the pneumatic variant. An example of a current waveform and the resulting pressure waveform near the orifice is shown in FIG. 2a. An example of a pressure waveform and the corresponding valve opening times for a pneumatic system are shown in FIG. 2b. Note that the pressure pulse is a push-pull type pressure that first rises above atmospheric pressure (0 kPa), then falls well below atmospheric, and finally returns back to atmospheric before the next pulse. This pushes and then pulls on a liquid meniscus to create highly controlled, efficient droplet ejection and breakup. Additional positive pulses of a lower amplitude are sometimes used to quell meniscus motion before the next ejection. The resolution of the MHD-LMJ printing process is determined by the size of the ejected droplet, which is in turn dependent on the size of the pre-manufactured orifice. For example, a nozzle equipped with a 500 μm orifice can be used eject droplets approximately 500 μm in diameter, limiting the resolution of the printer to ˜500 μm. In order to change the resolution of the printer, the nozzle needs to be replaced, which cannot be done during the printing process. Accordingly, this is a significant limitation of present day LMJ printing systems and methods.

### SUMMARY

This section provides a general summary of the disclosure, and is not a comprehensive disclosure of its full scope or all of its features.

In one aspect the present disclosure relates to an additive manufacturing system for droplet-on-demand jetting to manufacture a part from a feedstock. The system may comprise a printhead having a nozzle having first and second orifices for ejecting liquid droplets created from the feedstock. The first and second orifices have at least one differing characteristic. The system may also include a controller and a pressure pulse data file. The pressure pulse data file is accessible by the controller and contains data needed for generating pressure pulses designed to cause ejection from one or the other of the first and second orifices of the nozzle, as needed, to form the part. A pulse generating subsystem may be included which is responsive to the controller for generating the pressure pulses relative to the nozzle, and causing ejection of liquid droplets from at least one of the first and second orifices of the nozzle.

In another aspect the present disclosure relates to an additive manufacturing system for liquid droplet-on-demand jetting to manufacture a part from liquid droplets of a feedstock. The system may comprise a printhead having a nozzle having first and second orifices for ejecting liquid droplets created from the feedstock. The first and second orifices have differing dimensions. The system may further include a controller, a memory accessible by the controller, and a pressure pulse data file accessible stored in the memory and usable by the controller. The pressure pulse data file may include data needed for generating pressure pulses designed to cause ejection from one or the other of the first and second orifices, as needed, to form the part. The system may also include a pulse generating subsystem responsive to the controller for generating pressure pulses to cause ejection of liquid droplets from at least one of the first and second orifices of the nozzle of the printhead.

In still another aspect the present disclosure relates to a method for performing additive manufacturing using droplet jetting to manufacture a part from a feedstock. The method may comprise using a printhead having a nozzle having first and second orifices to receive a feedstock and to eject liquid droplets created from the feedstock from the first and orifices. The first and second orifices have at least one differing characteristic. The method further includes using a pulse generating subsystem to generate a plurality of differing pressure pulses. The method further includes applying the differing pressure pulses to a portion of the feedstock material contained in the nozzle of the printhead, to selectively cause ejection of liquid droplets from one of the first and second orifices during a printing operation to print the part.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a high level illustration of a current pulse and how the current pulse is used to energize a coil of a MHD-LMJ ejector to generate a single liquid metal droplet ejection;

FIG. 2a is a graph of a MHD-LMJ coil current waveform used to create a pressure pulse in a nozzle outfitted with a 500 μm orifice;

FIG. 2b shows two graphs associated with pneumatic valve signals, with one being an exemplary pressure pulse and the other being an exemplary valve drive voltage that results in the exemplary pressure pulse, for a nozzle with a 200 μm orifice;

FIG. 3 is a high level block diagram of one example of a system making use of the dual orifice printhead of the present disclosure;

FIG. 4 is a partial, isometric, cross-sectional side view of the nozzle of FIG. 3 with a 500 μm and 200 μm diameter orifices formed closely adjacent one another;

FIGS. 4a-4d show additional examples of different cross-sectional shapes that the orifices of the nozzle may take;

FIG. 5 is a set of graphs illustrating one example of four different pressure/time pulses that can be generated to cause ejection of a droplet from either the smaller orifice of the nozzle shown in FIG. 4, or from only the larger orifice of the nozzle, or from both orifices substantially simultaneously, to carry out four distinct ejection modes, namely a Fine Mode (e.g., eject only out of the smaller orifice), a Coarse Mode (e.g., eject only out of the larger orifice), an Infill Mode (e.g., eject a larger droplet and a medium droplet), and an Intermediate Infill Mode (e.g., eject two medium droplets);

FIG. 6 is a series of computational fluid dynamics (CFD) simulations showing how a droplet from only the small orifice of the nozzle of FIG. 4 is ejected during a “Fine Mode” pulse ejection sequence;

FIG. 7 is a series of CFD simulations showing how droplets can be ejected from both the small and large orifices of the nozzle of FIG. 4 during a “Medium Deposition Infill mode” pulse ejection sequence;

FIG. 8 is a series of CFD simulations showing how droplets can be ejected from both the small and large orifices of the nozzle of FIG. 4 during a “High Deposition Infill Mode”;

FIG. 9 is a series of high speed video images of the Fine Mode of ejection, where small aluminum alloy droplet is ejected from only the small orifice using a higher amplitude, short waveform shown in FIG. 5;

FIG. 10 is a series of high speed video images of the Coarse Mode of ejection where a large aluminum alloy droplet is ejected from only the larger orifice using a lower amplitude, long waveform shown in FIG. 5;

FIG. 11 is a series of high speed video images of the Fast Infill Mode of ejection where a large aluminum alloy droplet is ejected from the larger orifice and a medium sized droplet is ejected from the smaller orifice using the higher amplitude, long waveform shown in FIG. 5; and

FIG. 12 is a high level flowchart of one example of various operations that may be performed to carry out a printing operation in accordance with the present disclosure.

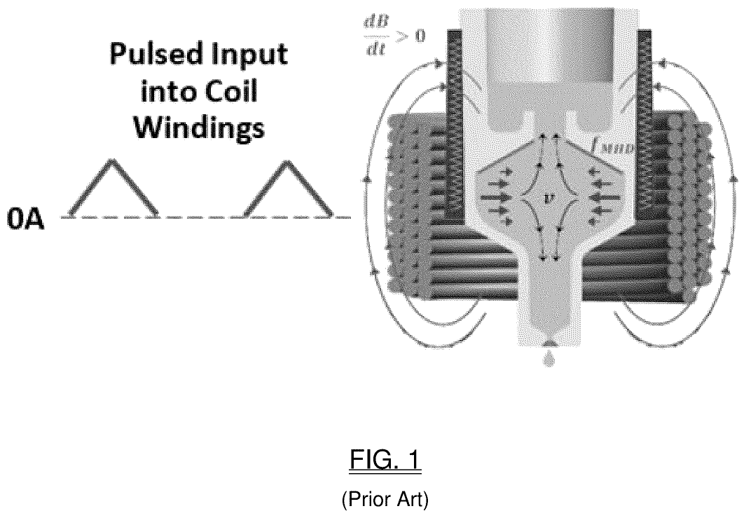

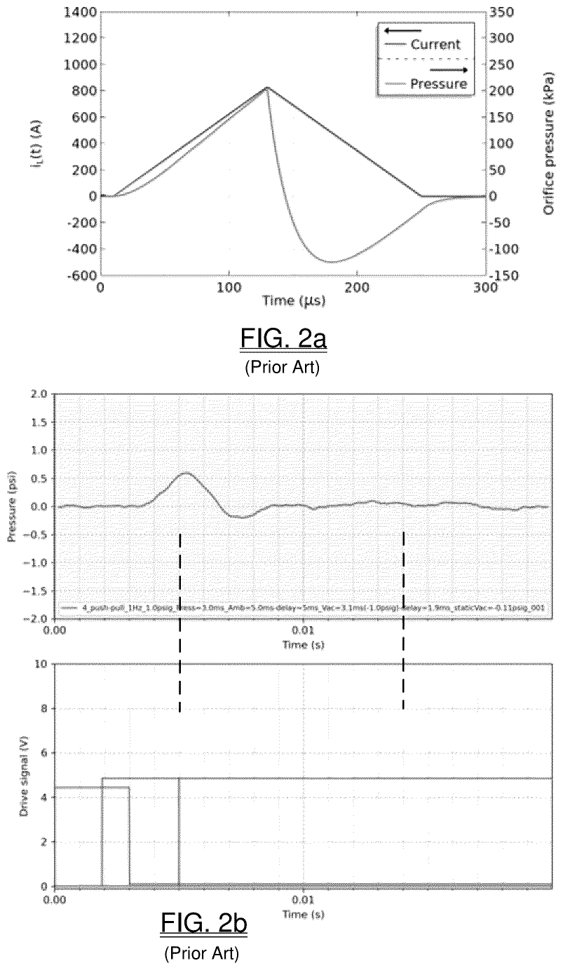

### DETAILED DESCRIPTION

Example embodiments will now be described more fully with reference to the accompanying drawings.

In various aspects and embodiments, the present disclosure relates to systems and methods for on-the-fly, multi-resolution metal droplet printing having one of more, or all, of the following features and/or capabilities, without limitation: (1) a nozzle with two or more orifices of varying diameter and length; (2) a set of corresponding pressure pulses that can selectively eject droplets out of some, but not all orifices in either MHD-LMJ or Pneumatic-LMJ; (3) the ability to change the pressure pulse at will, thereby allowing the user to swap between two or more droplet sizes at any time during the printing process and finally; (4) a computer-controlled motion system and software that digitally represents the 3D printed shape and maps the appropriate droplet sizes to create lower or higher resolutions in regions of the part. This, in turn, allows a single nozzle to be used for multiple resolutions and/or printing modes in a liquid metal jetting printing system.

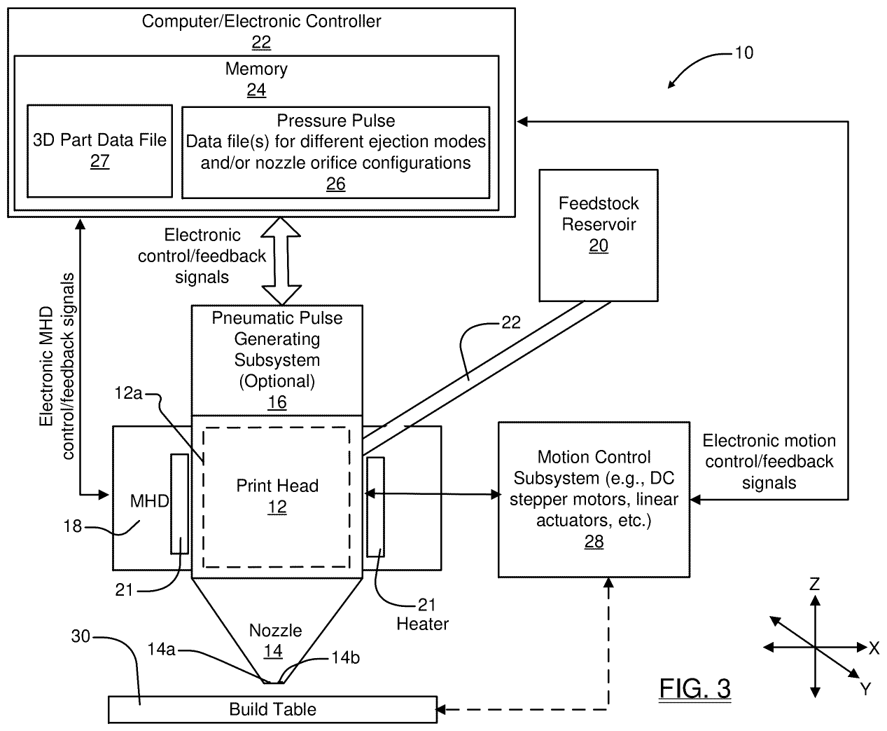

With brief reference to FIG. 3, one example of a system 10 in accordance with the present disclosure is shown. In this example the system 10 includes a printhead 12 having a nozzle 14. In some embodiments the nozzle includes two orifices 14a and 14b, with the orifice 14b being larger than the orifice 14a. In some embodiments the orifices 14a and 14b may be the same size, but it is expected that in most instances it will be preferred to use orifices of different dimensions to even further expand the fine, coarse, and infill printing capabilities of the system 10.

In some embodiments a pneumatic pulse generating subsystem 16 may be included which generates differing pneumatic signals which are applied to an interior area of the print head 12. The pneumatic signals create differing, controlled pressure pulses which cause ejection of droplets of feedstock selectively from one or the other, or both, of the orifices 14a and 14b of the nozzle 14, depending on a specific pulse profile being generated. In some embodiments the pneumatic pressure generating subsystem may be replaced by a magnetohydrodynamic (“MHD”) pulse generating subsystem 18 which produces highly controlled, differing magnetic field pulses (i.e., amplitude and/or duration) for causing highly controlled ejection of one or more droplets from the orifices 14a and/or 14b, depending on specific pulse profile of the magnetic pulses generated. In some embodiments, both the pneumatic pulse generating subsystem 16 and the MHD pulse generating subsystem 18 may be used, but it is expected that in most applications it will be preferred to use one or the other. In some applications, the specific feedstock material being used may have a bearing on whether the MHD pulse generating subsystem 18 or the pneumatic pulse generating subsystem 16 is more advantageous to use. For example, it may be advantageous to use the pneumatic pulse generating subsystem 16 for printing fluids with low electrical conductivity or high viscosity, whereas the MHD pulse generating subsystem 18 would be more advantageous for materials with high electrical conductivity in molten form. Additionally, the two subsystems 16 and 18 can be used in conjunction to create pressure waveforms that are difficult to achieve by either system alone.

In some embodiments the feedstock may be, without limitation, metal powder particles, polymer particles, or organic particles. Feedstock in wire, rod, shot or irregular form may also be used and then liquified when the system 10 is heated. The feedstock material may be supplied from a feedstock reservoir 20 via a suitable feedstock conduit 22. The feedstock may be supplied simply from the reservoir 20 or a hopper via gravity feed, or may be fed under pressure from a suitable pressurized reservoir (not shown). In some embodiments the feedstock may be in a solid powder form, or in wire form, and a heater 21 may be used to heat the feedstock after it is received with an internal reservoir area 12a of the printhead 12 to turn the powder or wire feedstock into a heated, molten feedstock (i.e., liquefied feedstock).

In some embodiments, the smaller orifice 14a may be about 50 μm to about 300 μm in diameter, and in some embodiments may be about 200 μm in diameter. In some embodiments the larger orifice 14b may be 300 μm to about 1000 μm in diameter, and in some embodiments about 500 μm in diameter.

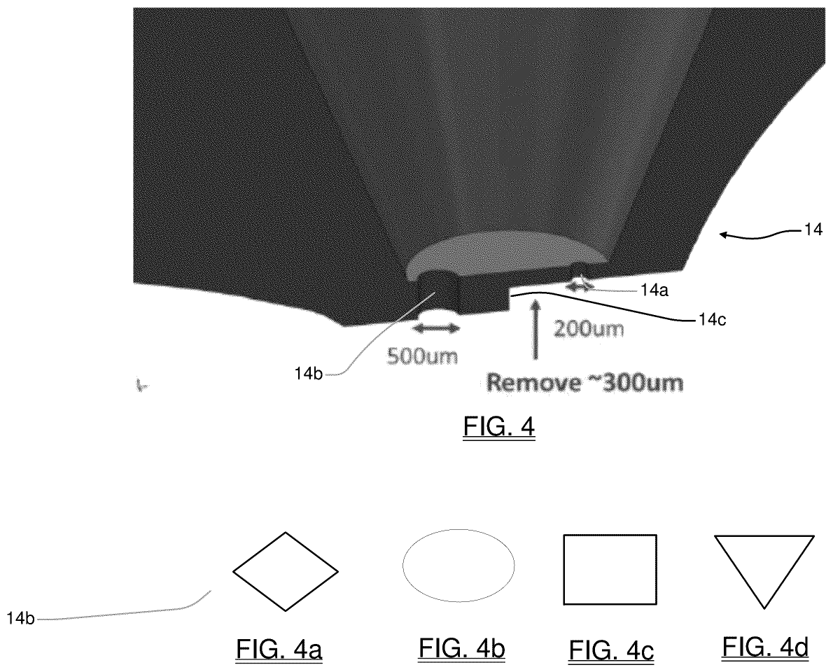

In some embodiments the orifices may be perfectly circular. In some embodiments the orifices may be oblong or may have other shapes, such as shown in FIGS. 4a-4d. It is expected that in most applications circular orifices are likely to be preferred. In some examples the orifices 14a and 14b may be differing shapes (e.g., one being circular and the other being oblong). In some embodiments only one orifice may be used, and in other embodiments three or more orifices may be present, with different pressure pulses used to selectively eject droplets from one or more, or all, of the orifices. In some embodiments, if differently shaped orifices are used, the pressure pulses generated by the MHD pulse generation subsystem 18 or the pneumatic pulse generation subsystem 16 may be tailored to selectively eject pulses from one or the other of the differently shaped orifices, taking into account how the specific shape of the orifice will affect the shape and/or volume of the droplet ejected.

The above are but a few examples, and the present disclosure is not limited to use with any specific number of orifices or any specific orifice shape (or shapes) or dimensions. The precise dimensions and/or shapes of the orifices 14a and 14b may be determined at least in part on the features of the structure or part being printed, and possibly on the specific type of feedstock material being used. Other considerations that may influence the dimensions and shapes of the orifices 14a and 14b may be the resolution required for various features of the part being printed, or possibly the overall speed that one desires to be able to print the part, or a combination of the above considerations, in addition to other factors or considerations. Accordingly, it will also be appreciated that the present disclosure is not limited to the use of any particular number of orifices, nor to any particular dimension(s) for the orifice(s). The specific dimensions selected for the orifices 14a and 14b will in many instances be selected in part based on considerations involving the resolution or features of the part being created, the time frame that one wishes to be able to fully print the part within, the material being printed, the hardness of the nozzle material, the droplet ejection rate, the method of orifice manufacturing, and other factors.

The system 10 may also include a computer/electronic controller 22 (hereinafter simply “controller 22”) for controlling one or more aspects of operation of the printhead 12. In some embodiments the controller 22 includes a memory 24 (e.g., non-volatile RAM/ROM/DRAM/EPROM/EEPROM, etc.) for storing a pressure pulse data file 26 and a 3D part data file 27. The pressure pulse data file 26 may include one or more pressure pulse profiles and other related data related to specific feedstock materials being used, and optionally algorithms relating to pressure pulse calculations needed to create ejections from the orifices 14a and 14b to form one or more different parts. The 3D part data file 27 may contain computer aided design (CAD) data in a layer-by-layer format for printing one or more different parts. In some embodiments the controller 22 generates and applies electronic MHD and/or pneumatic control signals to the MHD pulse generating subsystem 18 or the pneumatic pulse generating subsystem 16 to enable the subsystem to generate the pressure pulses needed to apply pulses in real time through one or the other of the orifices 14a and 14b. In some embodiments the controller 22 may receive feedback signals from the valving system 16 for the purpose of further controlling and/or adjusting the pressure pulses in real time. The controller 22 may also provide electronic heater control signals to a heater 21 (e.g., electric heater) which may be used to melt the feedstock material once the feedstock material is charged into an interior area 12a of the printhead 12. In some embodiments, the controller 22 may receive a feedback signal back from the heater 21 to help further control the heater in real time.

In some embodiments the controller 22 is configured to send electronic motion control signals to a motion control subsystem 28 which in turn controls motion of at least one of the print head 12 or a build table 30 (e.g., metallic, planar table) on which a part is being printed. In some embodiments the motion control subsystem 28 may include one or more DC stepper motors, linear actuators or other electrically driven devices for providing highly controlled movement along one or more, or all, of the X, Y and Z axes. In some embodiments the motion control subsystem 28 may instead be coupled to the build table 30, where the build table is supported on a movable stage (not shown) to drive the build table along one or more, or all, of the X, Y and Z axes, while the printhead 12 is held stationary in one X/Y axis location during printing. Both implementations are envisioned by the present disclosure.

FIG. 4 shows a highly enlarged, partial cutaway view of the nozzle 14. In one embodiment both of the nozzle orifices 14a (e.g., 200 μm) and 14b (e.g., 500 μm) are in communication with the internal reservoir 12a of the printhead 12. An important feature in obtaining the ability to achieve four distinct modes of ejection as described herein is the undercut 14c shown in FIG. 4. In this example 300 μm of material is removed from a bottom of the nozzle 14. So with a 200 μm orifice diameter, this enables the diameter-to-depth ratio of one-to-one to be achieved. Similarly, the depth of the larger orifice 14b is this about 500 μm while the depth of the larger orifice is also about 500 μm, so again a one-to-one diameter-to-depth ratio. In some embodiments it will be preferred to maintain this one-to-one diameter-to-depth ratio if the diameters of the orifices 14a and 14b should be made larger or smaller. However, this should be understood as a guideline, and in some instances (e.g., depending on the specific material being ejected), it may be that modifying these ratios slightly leads to even further enhanced control over the ejections from the two orifices 14a and 14b.

It should also be appreciated that the nozzle orifices 14a and 14b are shown in FIG. 4 as being equidistant from a longitudinal center axis of the nozzle 14. This is preferred in some embodiments, but it will be appreciated that in other embodiments, for example depending on the material being ejected, the specific part being made or other factors, it may be preferable to use a different spacing for the two orifices 14a and 14b from the longitudinal center axis.

An important factor in controlling ejections from the two orifices 14a and 14b is the natural “capillary time” of an orifice from which a droplet is being ejected. Assuming the nozzle 14 is filled with, for example and without limitation, molten aluminum, then the natural capillary time of the 200 μm orifice is:

$${t}_{C a p} = √ ( ρ {D}^{3} / 8 γ ) = ∼ 52 µs$$

and the capillary time of the 500 μm orifice is ˜206 μs. Here, ρ and y are the density and surface tension of the liquid metal, respectively. The variable D is the diameter of the ejection orifice. Note that the smaller orifice diameter has a shorter capillary time than the larger one, and so a shorter pulse is needed to eject droplets whose diameter is comparable to that of the orifice. Also, it is important to note that the different fluids will have a different capillary time, which means that the pressure pulse used for ejection needs to be tailored to the fluid. In some embodiments, still other factors besides the material being ejected may necessitate further adjustments to the pressure pulse to achieve optimum performance.

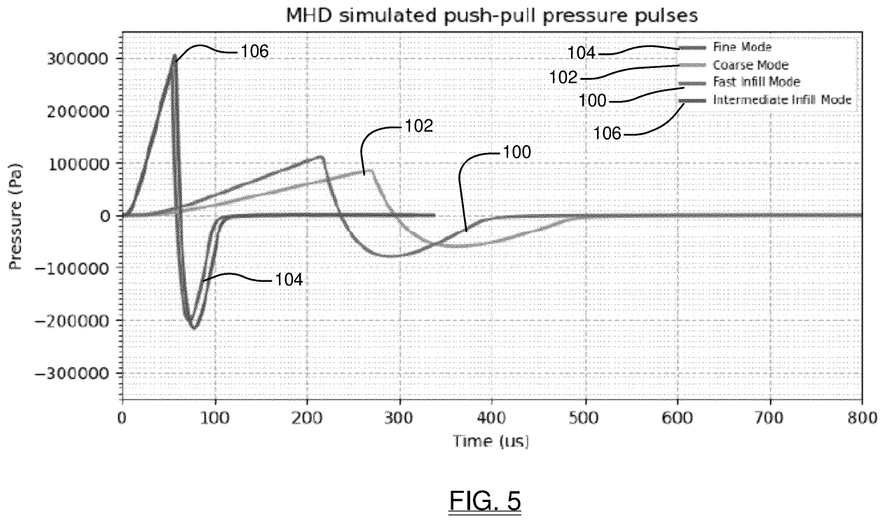

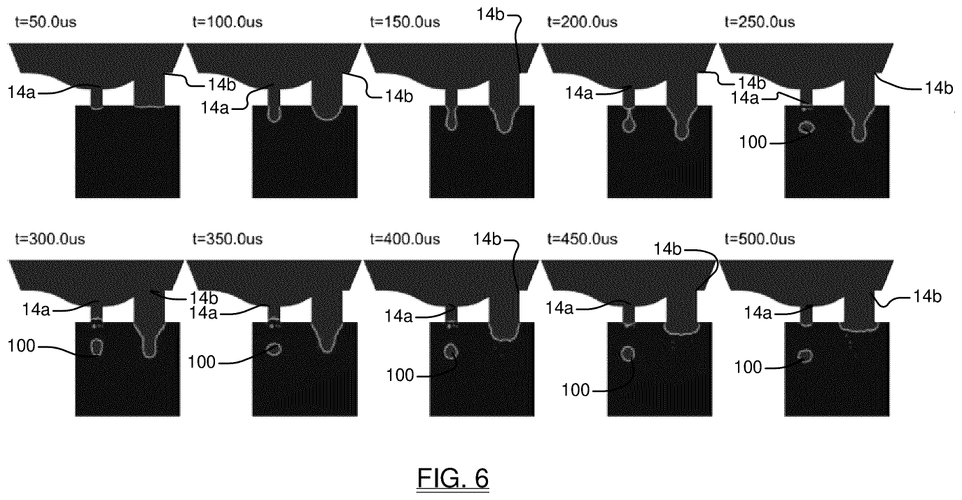

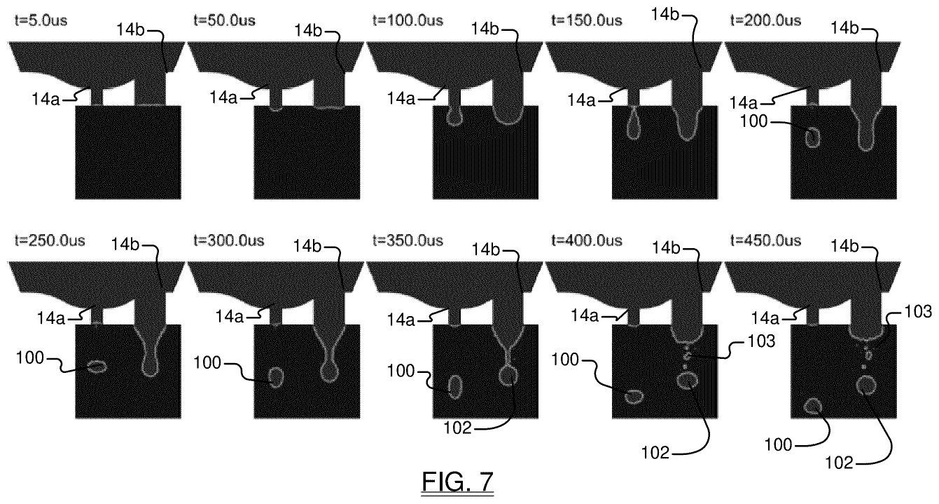

FIG. 5 shows simulated push-pull (i.e., pressurized then depressurized) pulses that enable the four distinct modes of material ejection described above, that is: the Fine Mode, which produces an ejection of a single 200 μm droplet only, represented by waveform 104; the Intermediate Infill Mode, which produces an ejection of two ˜300 μm (i.e., medium sized) droplets, represented by waveform 106; the Fast Infill Mode, which produces a set of 500 μm+300 μm droplets, as represented by waveform 100; and the Coarse Mode, which produces an ejection out of only the larger orifice 14b, represented by waveform 102. Note that the two droplet ejection can be forced to coalesce together by angling the larger orifice 14b towards the other 14a, effectively delivering one large droplet onto the substrate. In some embodiments the degree of coalescence can be further turned by varying the angling of the orifices to either greater or lesser angles and/or increasing or decreasing the distance separating the two orifices 14a and 14b.

FIGS. 6-8 are images that demonstrate a computational fluid dynamics (CFD) model that simulates the ejection of pure aluminum in all four modes outlined above. FIG. 6 shows an example of a Fine Mode of deposition using the pressure pulse 104 from FIG. 5, where a small droplet 100 is released from the small orifice (i.e., 200 μm), but the pressure pulse is not sufficiently large in magnitude and/or duration to cause a droplet to be released from the large orifice (i.e., 500 μm).

FIG. 7 shows an example of the Intermediate Infill Mode using the waveform 106 of FIG. 5, where the droplet 100 is a medium sized droplet ejected from the small orifice 14a, while a medium sized large droplet 102 is ejected substantially simultaneously from the large orifice 14b. Although some ejections exhibit unwanted tertiary ejections 103 (i.e., what may be termed as “satellite” droplets or “artifacts”), as seen in FIG. 7, further optimization of the geometry and pulse timing can effectively and/or substantially eliminate these artifacts.

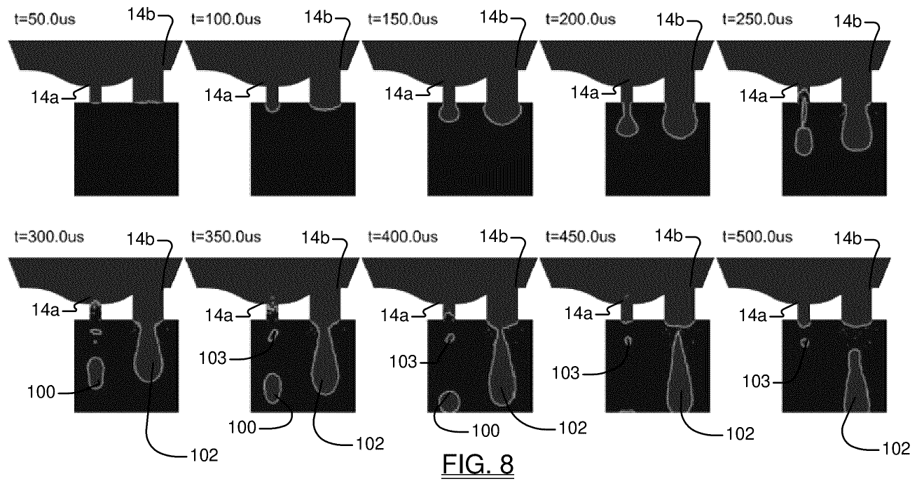

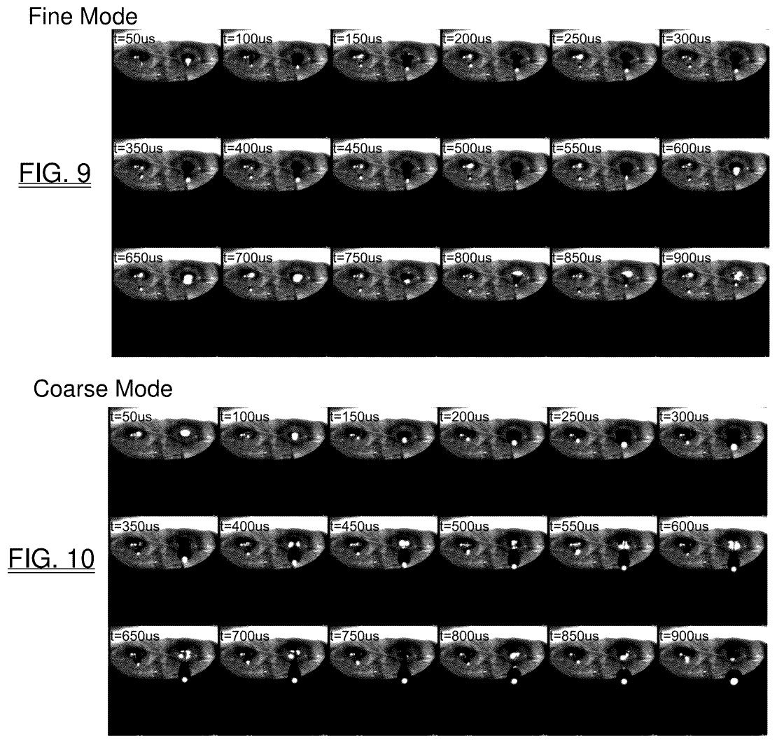

FIG. 8 shows an example the Fast Infill Mode where one large droplet 100 and one large droplet 102 are created substantially simultaneously using the longer waveform 100 shown in FIG. 5.

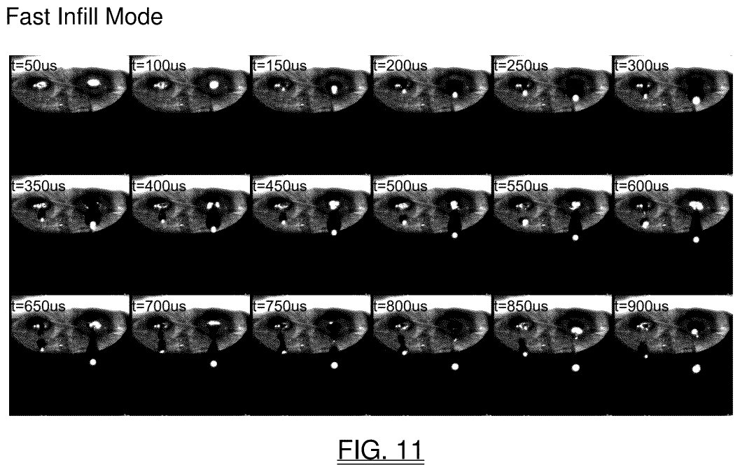

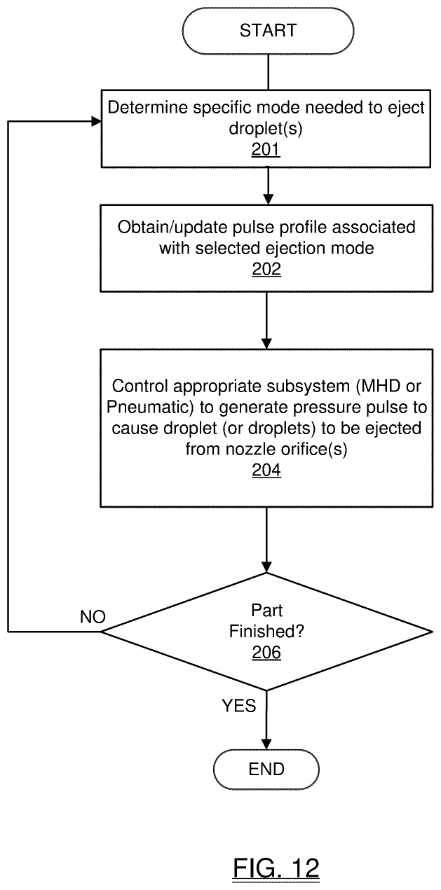

FIG. 9 is a series of images from a high speed of the ejection of a small aluminum droplet from only the small orifice 14a using the high amplitude, short waveform 104 from FIG. 5. FIG. 10 shows high speed video images of the Coarse Mode of ejection during which a large aluminum droplet is ejected from only the larger orifice 14b using the lower amplitude, long waveform 102 in FIG. 5. FIG. 11 shows high speed video images of the Fast Infill Mode of ejection during which a large aluminum droplet is ejected from the larger orifice 14a and a medium droplet is ejected from the smaller orifice 14a using the higher amplitude, long waveform 100 in FIG. 5.

FIG. 12 is a high level flowchart 200 showing one example of operations that may be performed using the system 100 to create a part. At operation 201 an initial check is made for the specific mode (e.g., Fine/Coarse/Intermediate Infill/Fast Infill Mode) that should be used to eject a droplet(s). At operation 202 the needed pulse profile is then obtained (e.g., by controller 22) to begin (or continue) making the part. At operation 204 appropriate control signals are transmitted to the appropriate pulse generation subsystem (e.g., MHD pulse generation subsystem 18 or pneumatic pulse generation subsystem 16) to generate the pressure pulses to cause droplets to be ejected from one or the other, or both, of the nozzle orifices 14a or 14b. The droplet is deposited on the build table 18 or on a previously formed layer of the part being formed. At operation 206 a check is made (e.g., by the controller 22) to determine if formation of the part is now complete. If this check produces a “No” answer, then operations 202-206 may be repeated. If the check at operation 206 indicates that the part is complete, then the method is complete. Optionally, one or more other operations may be performed on the part (e.g., annealing, peening, etc.) depending on the specific feedstock material that was used to make the part.

The new system 10 and methodology described herein provides a number of important advantages and benefits over pre-existing printing technology. For one, the system 10 enables the application of tailored pulses to LMJ, which is a burgeoning area, but which has been heretofore mostly limited to low technical readiness levels and research. Furthermore, multi-resolution printing is presently understood to have immense technical challenges associated with developing and constructing such systems. Liquid metal jetting is a new additive manufacturing technique, and to date, there are only very limited commercial systems which practice this printing technique. The system 10 and methodology described herein significantly expands the capabilities of a LMJ printing approach, which can be used to make parts with a wider range of 3D designs, and with significantly improved resolution, speed, or both. Most importantly, system 10 and the methodology allows for fast, high resolution rate printing within the same process, which is a unique and advantageous capability that increases the versatility of the printing process. Since the process can eject variable diameter droplets, it also opens up possibility of heterogeneous-resolution printed parts, which may have unique and improved mechanical properties.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1. An additive manufacturing system for droplet-on-demand jetting to manufacture a part from a feedstock, the system comprising:
a printhead having a nozzle having first and second orifices for ejecting liquid droplets created from the feedstock, wherein the first and second orifices have at least one differing characteristic;
a controller;
a pressure pulse data file accessible by the controller and containing data needed for generating pressure pulses designed to cause ejection from one or the other of the first and second orifices of the nozzle, as needed, to form the part; and
a pulse generating subsystem responsive to the controller for generating the pressure pulses relative to the nozzle, and causing ejection of liquid droplets from at least one of the first and second orifices of the nozzle.

2. The system of 1, wherein the at least one differing characteristic comprises a dimension of the first orifice relative to a dimension of the second orifice.

3. The system of claim 1, wherein the at least one differing characteristic comprises a cross sectional shape of the first orifice relative to a shape of the second orifice.

4. The system of claim 1, wherein the first orifice comprises a diameter of from 50 μm to 300 μm.

5. The system of claim 1, wherein the first orifice comprises a diameter of 200 μm.

6. The system of claim 1, wherein the second orifice comprises a diameter of from 300 μm to 1000 μm.

7. The system of claim 1, wherein the second orifice comprises a diameter of 500 μm.

8. The system of claim 1, wherein the pulse generating subsystem comprises a magnetohydrodynamic pulse generating subsystem configured to generate magnetic signals adapted to cause ejection of one or more of the droplets from one or more of the first and second orifices.

9. The system of claim 1, wherein the pulse generating subsystem comprises a pneumatic pulse generating subsystem configured to generate pneumatic pressure signals adapted to cause ejection of one or more of the droplets from one or more of the first and second orifices.

10. The system of claim 1, further comprising a motion control subsystem for causing relative motion between the printhead and a build table on which the part is being printed.

11. The system of claim 1, further comprising a heater for heating the feedstock received within an interior area of the printhead.

12. The system of claim 1, wherein at least one of:
a diameter to depth ratio of the first orifice is one-to-one; or
a diameter to depth ratio of the second orifice is one-to-one.

13. An additive manufacturing system for liquid droplet-on-demand jetting to manufacture a part from liquid droplets of a feedstock, the system comprising:
a printhead having a nozzle having first and second orifices for ejecting liquid droplets created from the feedstock, wherein the first and second orifices have differing dimensions;
a controller;
a memory accessible by the controller;
a pressure pulse data file accessible stored in the memory and usable by the controller and containing data needed for generating pressure pulses designed to cause ejection from one or the other of the first and second orifices, as needed, to form the part; and
a pulse generating subsystem responsive to the controller for generating pressure pulses to cause ejection of liquid droplets from at least one of the first and second orifices of the nozzle of the printhead.

14. The system of claim 13, wherein the pulse generating subsystem comprises a magnetohydrodynamic push-pull pulse generating subsystem configured to generate magnetic signals adapted to cause ejection of one or more of the droplets from one or more of the first and second orifices.

15. The system of claim 13, wherein the pulse generating subsystem comprises a pneumatic pulse generating subsystem configured to generate pneumatic pressure signals adapted to cause ejection of one or more of the droplets from one or more of the first and second orifices.

16. The system of claim 13, further comprising a motion control subsystem for causing relative motion between the printhead and a build table on which the part is being printed.

17. The system of claim 13, wherein:
the first orifice is circular and has a diameter of between 50 μm to 300 μm; and
the second orifice is circular and has a diameter of between 300 μm to 1000 μm.

18. A method for performing additive manufacturing using droplet-on-demand jetting to manufacture a part from a feedstock, the method comprising:
using a printhead having a nozzle having first and second orifices to receive a feedstock and to eject liquid droplets created from the feedstock from the first and orifices, wherein the first and second orifices have at least one differing characteristic;
using a pulse generating subsystem to generate a plurality of differing pressure pulses;
applying the differing pressure pulses to a portion of the feedstock material contained in the nozzle of the printhead, to selectively cause ejection of liquid droplets from the first and second orifices during a printing operation to print the part.

19. The method of claim 18, wherein the using a pulse generating subsystem comprises using at least one of a magnetohydrodynamic pulse generating subsystem or a pneumatic pulse generating subsystem to generate differing magnetic pulses in a vicinity of the nozzle to cause the ejection of the liquid droplets from one or the other, or both, of the orifices.

20. The method of claim 18, wherein using the printhead having a nozzle with first and second orifices comprises using two orifices of different dimensions.
